(19) United States
(12) Patent Application Publication
(10) Pub. No.: US 2019/0247790 A1
(43) Pub. Date: Aug. 15, 2019

(54) SURFACE TEXTURED STRUCTURAL CATALYST AND APPLICATIONS THEREOF

(71) Applicant: Cormetech, Inc., Durham, NC (US)

(72) Inventors: Chris E. DIFRANCESCO, Durham, NC (US); Gavin MACINNES, Durham, NC (US); Christian TREFZGER, Durham, NC (US); William BUYNITZKY, Chapel Hill, NC (US)

(21) Appl. No.: 16/337,784

(22) PCT Filed: Sep. 28, 2017
(86) PCT No.: PCT/US17/54064

§ 371 Date: Mar. 28, 2019

Related U.S. Application Data
(60) Provisional application No. 62/401,002, filed on Sep. 28, 2016.

(51) Int. Cl. B01D 53/86; B01D 53/88; B01J 35/04

(52) U.S. Cl. CPC B01D 53/8631; B01D 53/885; B01J 35/04; B01D 2257/404; B01D 2255/9207; B01D 2255/20707; B01D 2255/20769; B01D 2255/20776; B01D 2258/0283

(57) ABSTRACT

In one aspect, structural catalyst bodies are described herein having cross-sectional flow channel geometries and surface features for enhanced catalytic activity. A structural catalyst body comprises an outer peripheral wall and a plurality of inner partition walls defining individual flow channels of rectangular cross-section, wherein one or more of the inner partition walls comprise surface protrusions, surface indentations or combinations thereof.

### RELATED APPLICATION DATA

The present application hereby claims priority pursuant to 35 U.S.C. § 119(e) to U.S. Provisional Patent Application Ser. No. 62/401,002 filed Sep. 28, 2016 which is incorporated herein by reference in its entirety.

### FIELD

The present invention relates to catalyst compositions and, in particular, to structural catalyst bodies having cross-sectional flow channel geometry and surface features for enhanced catalytic activity.

### BACKGROUND

The high toxicity of nitrogen oxides and their role in the formation of acid rain and tropospheric ozone have resulted in the imposition of strict standards limiting the discharges of these chemical species. To meet these standards, it is generally necessary to remove at least part of these oxides present in the exhaust gases from stationary or mobile combustion sources. Denitration or selective catalytic reduction (SCR) technology is commonly applied to combustion-derived flue gases for removal of nitrogen oxides. The denitration reaction comprises the reaction of nitrogen oxide species in the gases, such as nitrogen oxide (NO) or nitrogen dioxide (NO₂), with a nitrogen containing reductant, such as ammonia or urea, resulting in the production of diatomic nitrogen (N₂) and water.

In addition to nitrogen oxides, sulfur dioxide (SO₂) is a chemical species often present in combustion-flue gases that causes great environmental concern. Sulfur dioxide that is present in fossil fuel combustion flue-gases is partly oxidized to sulfur trioxide (SO₃) which reacts with water to form sulfuric acid. The formation of sulfuric acid from the oxidation of sulfur dioxide in combustion flue-gases can increase corrosion problems in downstream equipment, can increase power costs associated with air pre-heaters due to the increased temperature required to keep the acid-containing flue-gas above its dew point, and can cause increased opacity in the stack gases emitted to the atmosphere.

Catalyst systems for the removal of nitrogen oxides can increase the amount of sulfur dioxide oxidation since the catalytic material utilized in selective catalytic reduction can additionally effectuate the oxidation of sulfur dioxide. As a result, the reduction in the nitrogen oxide content of a combustion flue-gas can have an undesirable side-effect of increasing SO₃ formation in the combustion flue-gas.

Combustion flue-gases containing nitrogen oxides and a significant sulfur dioxide content are commonly produced from the combustion of coal. Coal-fired combustion flue-gases contain high amounts of particulate matter, especially in the form of ash. This particulate matter has the ability to clog the cells of a monolithic structural catalyst body resulting in a reduced catalytic performance and efficiency. Individual ash particles alone can plug catalyst cells or ash particles can aggregate to produce a plug. Moreover, smaller particulate matter can plug catalytic pores located within inner partition walls of the catalyst body.

### SUMMARY

In one aspect, structural catalyst bodies are described herein having cross-sectional flow channel geometries and surface features for enhanced catalytic activity. In some embodiments, the structural catalyst bodies are suitable for use in high particulate matter environments. Briefly, a structural catalyst body comprises an outer peripheral wall and a plurality of inner partition walls defining individual flow channels of rectangular cross-section, wherein one or more of the inner partition walls comprise surface protrusions, surface indentations or combinations thereof. As described further herein, the surface protrusions and/or surface indentations can exhibit a uniform arrangement along a width of the inner partition walls. In other embodiments, the surface protrusions and/or surface indentations exhibit a non-uniform distribution along a width of the inner partition walls.

In another aspect, a structural catalyst body comprises an outer peripheral wall and a plurality of inner partition walls defining individual flow channels of rectangular cross-section, the individual flow channels having a hydraulic diameter of at least 5.5 mm and an aspect ratio of at least 1.2:1. The structural catalyst body also has a hydraulic diameter formed by the outer peripheral wall of at least 100 mm, wherein at least 50 percent of the inner partition walls connected to the outer peripheral wall are at least 10 percent thicker on average than the remaining inner partition walls. In some embodiments, all of the inner partition walls connected to the outer peripheral wall are at least 10 percent thicker on average than the remaining inner partition walls.

In another aspect, catalyst modules are described herein. A catalyst module, in some embodiments, comprises a framework and a plurality of structural catalyst bodies disposed in the framework, the structural catalyst bodies comprising an outer peripheral wall and a plurality of inner partition walls defining individual flow channels of rectangular cross-section, wherein one or more of the inner partition walls comprise surface protrusions, surface indentations or combinations thereof. In some embodiments, at least two of the structural catalyst bodies of the module are arranged in series. In such embodiments, a gap may exist between the two structural catalyst bodies in series. The gap, in some embodiments, has length of at least 2 times the hydraulic diameter of the individual flow channels.

In a further aspect, methods of treating a fluid stream, such as a flue gas or combustion gas stream, are described herein. For example, a method of treating a fluid stream comprises flowing the fluid through a structural catalyst body comprising an outer peripheral wall and a plurality of inner partition walls defining individual flow channels of rectangular cross-section, wherein one or more of the inner partition walls comprise surface protrusions, surface indentations or combinations thereof and catalytically reacting at least one chemical species in the fluid stream. Catalytically reacting at least one chemical species in the fluid stream can comprise catalytically reducing nitrogen oxides in the fluid stream. Moreover, catalytically reacting at least one chemical species in the fluid stream can also comprise oxidizing ammonia and/or mercury in the fluid stream. In some embodiments, the fluid stream is a combustion gas stream comprising particulate matter. For example, the combustion gas stream can comprise greater than 1 g/Nm³ of fly ash.

These and other embodiments are described in greater detail in the detailed description which follows.

### BRIEF DESCRIPTION OF THE DRAWINGS

FIG. 1 illustrates an end view of a structural catalyst body according to one embodiment described herein.

FIG. 2 illustrates an end view of a structural catalyst body according to one embodiment described herein.

FIG. 3 illustrates an end view of a structural catalyst body according to one embodiment described herein.

FIG. 4 illustrates surface protrusions and surface indentations along a width of an inner partition wall of a structural catalyst body according to some embodiments described herein.

FIG. 5 illustrates a catalyst module comprising structural catalyst bodies described herein arranged in a serial format.

### DETAILED DESCRIPTION

The present invention can be understood more readily by reference to the following detailed description, examples and drawings and their previous and following descriptions.

Elements, apparatus and methods of the present invention, however, are not limited to the specific embodiments presented in the detailed description, examples and drawings. It should be recognized that these embodiments are merely illustrative of the principles of the present invention. Numerous modifications and adaptations will be readily apparent to those of skill in the art without departing from the spirit and scope of the invention.

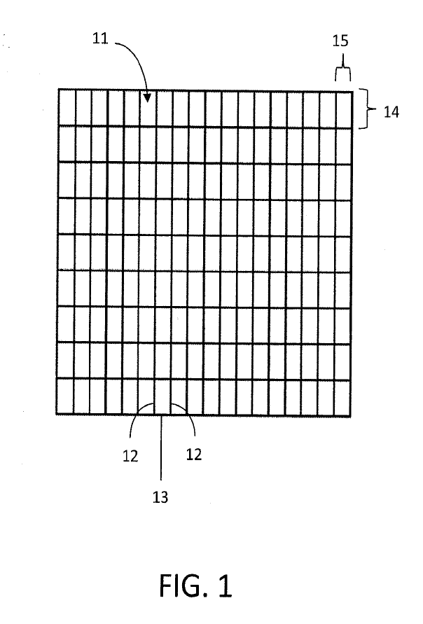

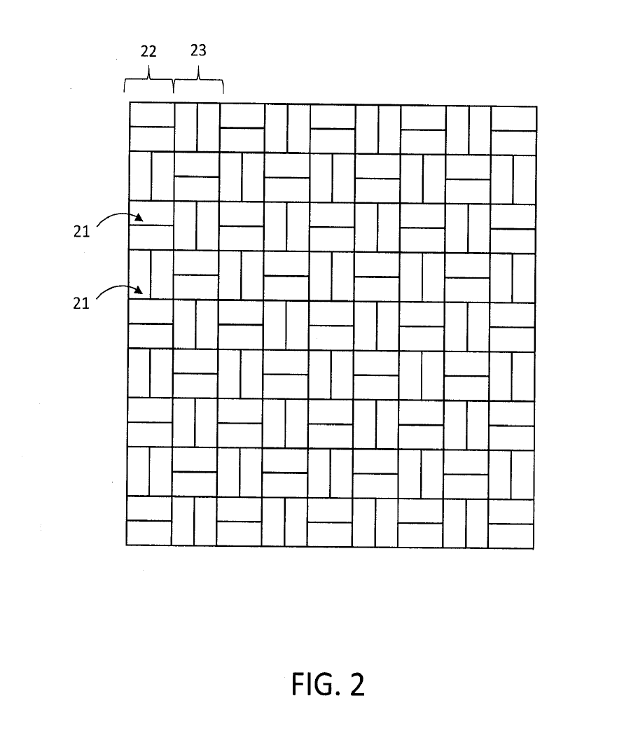

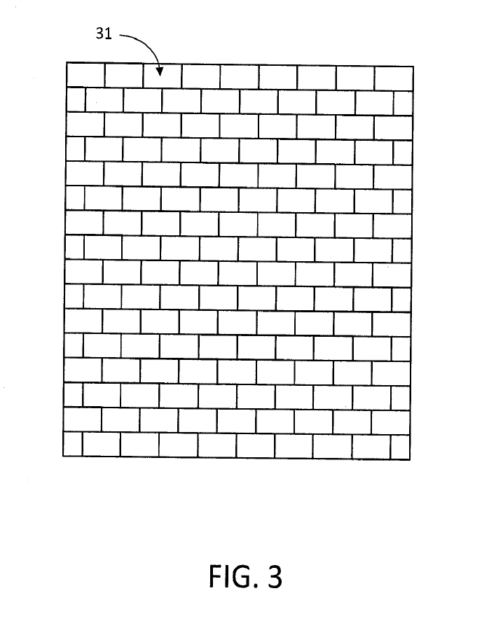

In one aspect, structural catalyst bodies are described herein. A structural catalyst body comprises an outer peripheral wall and a plurality of inner partition walls defining individual flow channels of rectangular cross-section, wherein one or more of the inner partition walls comprise surface protrusions, surface indentations or combinations thereof. FIG. 1 illustrates an end view of a structural catalyst body according to one embodiment described herein. As provided in FIG. 1, a rectangular flow channel 11 comprises two long partition walls 12 intersecting two short partition walls 13. The terms long and short are used relative to one another to establish the rectangular cross-sectional geometry. The width 14 of a long partition wall is bounded by the two short partition walls 13. Likewise, the width 15 of a short partition wall 13 is bounded by the two long partition walls 12. FIG. 2 illustrates an end view of a structural catalyst body according to another embodiment wherein the rectangular flow channels 21 are arranged into subsets 22, 23 of alternating orientation. In the embodiment of FIG. 2, each subset 22 contains two rectangular flow channels 21. In other embodiments, a subset may contain more than two rectangular flow channels. The rectangular flow channels 21 of a subset 22, 23 can exhibit a vertical orientation or horizontal orientation with respect to the long axis of the rectangle. As illustrated in FIG. 2, adjacent subsets 22, 23 have differing orientation of the rectangular flow channels 21, yielding an alternating pattern. It is contemplated that flow channels subsets can be arranged to provide any desired pattern of rectangular flow channel orientation. FIG. 3 illustrates an end view of a structural catalyst body according to another embodiment wherein the rectangular flow channels 31 are staggered relative to one another.

In having rectangular format, flow channels can display a cross-sectional aspect ratio (long side:short side) of at least 1.2:1. Additionally, a flow channel can exhibit a hydraulic diameter of at least 1.1 mm. Hydraulic diameter of a rectangular flow channel is defined as being equal to the cross-sectional area of the channel normal to the direction of fluid flow multiplied by four and divided by the value of the outer perimeter of the flow channel. In some embodiments, a fluid flow channel has a hydraulic diameter of at least 5.5 mm.

Similarly, the structural catalyst body can also exhibit a hydraulic diameter. In some embodiments, the structural catalyst body has a hydraulic diameter of at least 100 mm or at least 150 mm. Hydraulic diameter of the structural catalyst body is defined as being equal to the cross-sectional area normal to the direction of fluid flow through the body multiplied by four and divided by the value of the outer perimeter of the outer peripheral wall. Moreover, a structural catalyst body described herein can have a transverse compressive strength of at least 1.0 kg/cm². In some embodiments, a structural catalyst body has a transverse compressive strength of greater than 3.0 kg/cm² or greater than 4.0 kg/cm². Transverse compressive strength of structural catalyst bodies described herein may be measured with a compressive testing apparatus such as Tinius Olson 60,000 lb. Super “L” Compression Testing Machine that displays a maximum compression load of 30,000 kg and can be obtained from Tinius Olsen of Willow Grove, Pa. Samples for transverse compressive strength testing may be prepared by cutting a structural catalyst into sections typically of 150 mm in length, but at least 50 mm in length, wherein each section can serve as an individual test sample.

Ceramic wool of 6 mm thickness may be spread under and over the pressure surface of the sample, and the wrapped sample set in a vinyl bag in the center of the pressure plates. The pressure plates used in the testing may be stainless steel with dimensions of 160 mm×160 mm. Transverse compression strength is quantified with the side surface on the bottom with the compressive load applied in the direction parallel to the cross-section of the honeycomb structure and normal to the partition walls. The compressive load is thus applied in the direction normal to the direction of flow in the flow channels. The compressive load can be applied as delineated in Table 1.

TABLE I
Application of Compressive Loads

| Full Scale Load | Compression Speed |
|---|---|
| 3,000 kg | 25 kg/s |
| 6,000 kg | 50 kg/s |
| 15,000 kg | 125 kg/s |

The maximum transverse compressive load W (kg) withstood by the samples is registered by the apparatus. The transverse compressive strength is subsequently calculated from the maximum compressive load in kilograms-force (kgf) by dividing the value of the maximum compressive load by the surface area over which the load was applied.

As described herein, surface protrusions and/or surface indentations are arranged along a width of the inner partition walls. The surface protrusions and/or surface indentations, for example, can be arranged along the width 14 of the long partition walls 12, width 15 of the short partition walls 13 or various combinations thereof. In one embodiment, surface protrusions and/or surface indentations are arranged solely along the width of the long walls of the flow channels. In some embodiments, the surface protrusions and/or surface indentations exhibit a uniform arrangement along width of the inner partition walls. Alternatively, the surface protrusions and/or surface indentations exhibit a non-uniform arrangement along width of the inner partition walls. For example, the surface protrusions and/or surface indentations can be located along a central region of the width of the inner partition walls. In some embodiments, the central region is centered about the midpoint of the inner partition wall and occupies up to 75 percent of the width of the inner partition wall. Additionally, surface protrusions and/or surface indentations may occupy greater than 25 percent of the surface area of one or more inner partition walls, such as the long partition walls 12 of the rectangular flow channels.

Additionally, the surface protrusions and/or surface indentations can be spaced from one another. In some embodiments, surface protrusions and/or surface indentations can have spacing of at least 0.025 mm. Alternatively, the surface protrusions and/or surface indentations can be contiguous with one another.

The surface protrusions and/or surface indentations can also extend the entire length of the flow channels. In other embodiments, the surface protrusions and/or surface indentations extend less than the entire length of the flow channels. Surface protrusions can have any shape and dimensions not inconsistent with the objectives of the present invention. In some embodiments, surface protrusions have a hemispherical cross-sectional profile. In other embodiments, surface protrusions have a polygonal cross-sectional profile. Further, the surface protrusions can have a cross-sectional profile including curved and straight surfaces. For example, the surface protrusions can have a truncated hemispherical cross-sectional profile. Additionally, the surface protrusions can have a minimum height of 0.025 mm. Height of the surface protrusions is measured relative to the average plane of the surface. Height of the surface protrusions can be selected according to several considerations including, but not limited to, desired fluid flow characteristic through the flow channels, positioning of the surface protrusions along inner partition wall width and catalytic activity of the structural catalyst body. In some embodiments, surface protrusions exhibit the same or substantially the same height. In other embodiments, surface protrusions exhibit differing heights.

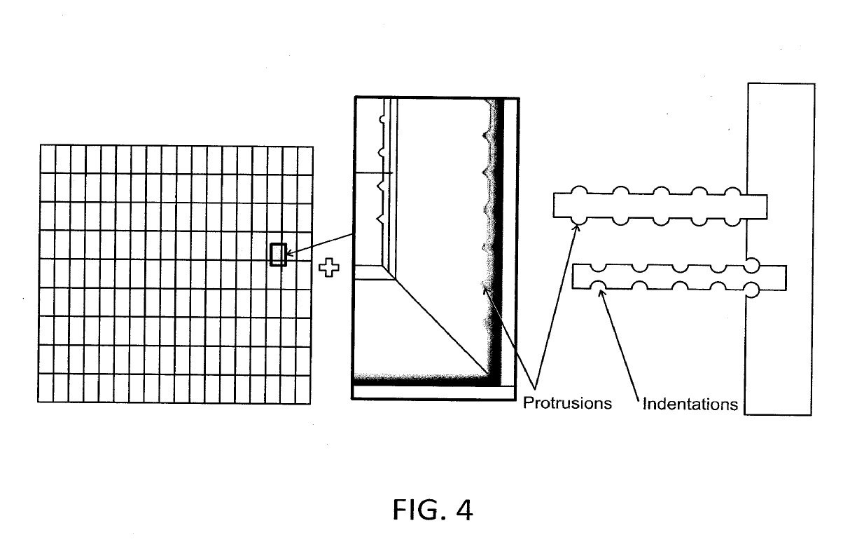

Surface indentations can have any shape and dimensions not inconsistent with the objectives of the present invention. In some embodiments, surface indentations have a hemispherical cross-sectional profile. In other embodiments, surface indentations can have a polygonal cross-sectional profile. Further, the surface indentations can have a cross-sectional profile including curved and straight surfaces, such as a truncated hemispherical cross-sectional profile. Additionally, the surface indentations can have a minimum depth of 0.025 mm. Depth of the surface protrusions is measured relative to the average plane of the surface. Depth of the surface indentations can be selected according to several considerations including, but not limited to, desired fluid flow characteristic through the flow channels, positioning of the surface indentations along inner partition wall width and catalytic activity of the structural catalyst body. In some embodiments, surface indentations exhibit the same or substantially the same depth. In other embodiments, surface indentations exhibit differing depths. FIG. 4 illustrates surface protrusions or bumps as well as indentations along the width of an inner partition wall according to some embodiments described herein.

Structural catalyst bodies having design and surface features described herein can be formed of any composition not inconsistent with objectives of the present invention. In some embodiments, the outer peripheral wall and inner partition walls are formed from a support material such as an inorganic oxide composition, including refractory metal oxide compositions. The inorganic oxide composition, in some embodiments, comprises titania (TiO₂), alumina (Al₂O₃), zirconia (ZrO₂), silica (SiO₂), silicate or mixtures thereof. In some embodiments, the chemical composition comprises an inorganic oxide composition in an amount ranging from about 50 weight percent to 100 weight percent. In some embodiments, the inorganic oxide composition is sintered or otherwise heat treated to increase the mechanical integrity of the structural catalyst body. The structural catalyst body can also comprise at least 0.1 weight percent catalytically active metal functional group. In some embodiments, the catalytically active metal functional group includes one or more metals selected from the group consisting of vanadium, tungsten, molybdenum, platinum, palladium, ruthenium, rhodium, rhenium, iron, gold, silver, copper and nickel and alloys and oxides thereof. In some embodiments, one or more catalytic materials of structural catalyst bodies described herein are suitable for SCR applications and processes. In some embodiments, for example, catalytic material comprises V₂O₅, WO₃ or MoO₃ or mixtures thereof.

Structural catalyst bodies can be formed by any process operable to impart the features and properties described herein. In some embodiments, for example, structural catalyst bodies are formed by extruding an inorganic oxide composition. Rectangular cross-section of the flow channels in addition to surface protrusions and/or surface indentations can be provided by the extrusion process. The inorganic oxide composition can contain catalytic material or can be inert. In embodiments wherein the extruded inorganic oxide composition is inert, catalytic material can be added via impregnation and/or washcoating processes. In some embodiments, the extruded inorganic oxide composition comprises catalytic material and additional catalytic material is added via impregnation and/or washcoating processes.

Structural catalyst bodies described herein can exhibit enhanced catalytic activity compared to structural catalyst bodies of identical composition but lacking rectangular flow channels and/or surface features of protrusions and/or indentations. In some embodiments, structural catalyst bodies described herein display greater catalytic activity for nitrogen oxide removal relative to comparative structural catalyst bodies. For example, a structural catalyst body described herein can exhibit catalytic activity for nitrogen oxide removal that is at least 5% greater than a body of identical composition and hydraulic diameter but lacking rectangular flow channels and/or surface features. Additionally, a structural catalyst body described herein can exhibit catalytic activity for nitrogen oxide removal that is at least 5% greater than a body of identical composition, rectangular flow channels and hydraulic diameter but lacking surface protrusions and/or indentations. Catalytic activity of structural catalyst bodies described herein for NOₓ removal was compared to catalyst bodies of differing structure by finite element modeling. The results of the modeling are provided in Table II.

TABLE II
Catalytic Activity for NOx Removal

| Number of Cells | | | Protrusions* | Relative K = | | | |
|---|---|---|---|---|---|---|---|
| along each side of | Composition | Dh | (entire length | SV × (1-NOₓ | | | |
| catalyst body | TiO₂:WO₃:V₂O₅ | (mm) | of flow channels) | Conversion %) | Relative K | Relative K | Relative K |
| 14 × 14 square | 90:5:1 | 10 | None | 1 | | | |
| 18 × p rectangle | 90:5:1 | 10 | None | 1.06 | 1 | 1 | 1 |
| 18 × 9 rectangle - | 90:5:1 | 10 | None | 1.13 | 1.07 | | |
| 2 layers | | | | | | | |
| 18 × 9 rectangle | 90:5:1 | 10 | Height - 0.35 | 1.21 | | 1.14 | |
| and surface | | | mm × 0.2 mm | | | | |
| protrusions | | | Spacing - 0.7 mm | | | | |
| 18 × 9 rectangle | 90:5:1 | 10 | Height - 0.35 | 1.29 | | | 1.22 |
| and surface | | | mm × 0.2 mm | | | | |
| protrusions - | | | Spacing - 0.7 mm | | | | |
| 2 layers | | | | | | | |

*Positioned on long walls of rectangular cross-section only

SV=(flue gas flow rate)/(catalyst volume)
Volume=cross-section of end of monolith×length
NO conversion %=(NOₓ in−NOₓ out)/(NOₓ in)
As provided in Table II, structural catalyst bodies having rectangular flow channel cross-section in conjunction with surface protrusions along the long inner partition walls of the rectangles exhibited NOₓ catalytic activity superior to structural catalyst bodies having flow channels of square and rectangular cross-section.

In another aspect, a structural catalyst body comprises an outer peripheral wall and a plurality of inner partition walls defining individual flow channels of rectangular cross-section, the individual flow channels having a hydraulic diameter of at least 5.5 mm and an aspect ratio of at least 1.2:1. The structural catalyst body also has a hydraulic diameter formed by the outer peripheral wall of at least 100 mm, wherein at least 50 percent of the inner partition walls connected to the outer peripheral wall are at least 10 percent thicker on average than the remaining inner partition walls. In some embodiments, all of the inner partition walls connected to the outer peripheral wall are at least 10 percent thicker on average than the remaining inner partition walls. In some embodiments, inner partition walls adjacent to and collinear with thicker inner partition walls are also at least 10 percent thicker on average than the remaining inner partition walls. Moreover, the structural catalyst body can also have a transverse compressive strength of at least 1.5 kg/cm².

In another aspect, catalyst modules are described herein. A catalyst module, in some embodiments, comprises a framework and a plurality of structural catalyst bodies disposed in the framework, the structural catalyst bodies comprising an outer peripheral wall and a plurality of inner partition walls defining individual flow channels of rectangular cross-section, wherein one or more of the inner partition walls comprise surface protrusions, surface indentations or combinations thereof. The structural catalyst bodies can have any properties and/or construction described herein above.

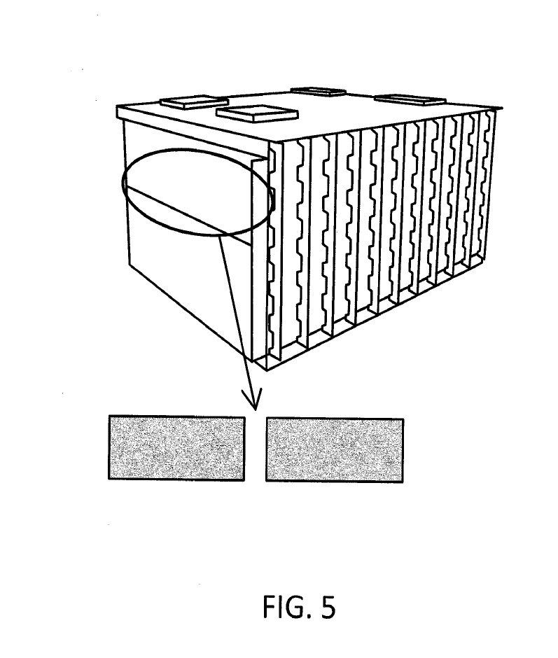

In some embodiments, at least two of the structural catalyst bodies of the module are arranged in series. In such embodiments, a gap may exist between the two structural catalyst bodies in series. The gap, in some embodiments, has length of at least 2 times the hydraulic diameter of the individual flow channels. In some embodiments, the gap has a length of 3 to 10 times the hydraulic diameter of the individual flow channels. FIG. 5 illustrates a catalyst module comprising structural catalyst bodies described herein arranged in a serial format according to one embodiment.

In a further aspect, methods of treating a fluid stream, such as a flue gas or combustion gas stream, are described herein. For example, a method of treating a fluid stream comprises flowing the fluid through a structural catalyst body comprising an outer peripheral wall and a plurality of inner partition walls defining individual flow channels of rectangular cross-section, wherein one or more of the inner partition walls comprise surface protrusions, surface indentations or combinations thereof and catalytically reacting at least one chemical species in the fluid stream. Catalytically reacting at least one chemical species in the fluid stream can comprise catalytically reducing nitrogen oxides in the fluid stream. Moreover, catalytically reacting at least one chemical species in the fluid stream can also comprise oxidizing ammonia and/or mercury in the fluid stream. In some embodiments, the fluid stream is a combustion gas stream comprising particulate matter. For example, the combustion gas stream can comprise greater than 1 g/Nm³ of fly ash.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A structural catalyst body comprising:
an outer peripheral wall and a plurality of inner partition walls defining individual flow channels of rectangular cross-section, wherein one or more of the inner partition walls comprise surface protrusions, surface indentations or combinations thereof.

2. The structural catalyst body of claim 1, wherein the surface protrusions and/or surface indentations exhibit a uniform arrangement along a width of the inner partition walls.

3. The structural catalyst body of claim 1, wherein the surface protrusions and/or surface indentations exhibit a non-uniform arrangement along a width of the inner partition walls.

4. The structural catalyst body of claim 3, wherein the surface protrusions and/or surface indentations are located along a central region of the width of the inner partition walls.

5. The structural catalyst body of claim 1, wherein the surface protrusions and/or surface indentations are located on the inner partition walls forming long sides of the rectangular cross-section.

6. The structural catalyst body of claim 1, wherein the surface protrusions and/or surface indentations have a spacing of at least 0.025 mm.

7. The structural catalyst body of claim 1, wherein the surface protrusions and/or surface indentations are contiguous with one another.

8. The structural catalyst body of claim 1, wherein the surface protrusions have a hemispherical cross-sectional profile.

9. The structural catalyst body of claim 1, wherein the surface protrusions have a polygonal cross-sectional profile.

10. The structural catalyst body of claim 1, wherein the surface protrusions have a minimum height of 0.025 mm.

11. The structural catalyst body of claim 1, wherein the surface indentations have a hemispherical cross-sectional profile.

12. The structural catalyst body of claim 1, wherein the surface indentations have a polygonal cross-sectional profile.

13. The structural catalyst body of claim 1, wherein the surface indentations have a minimum depth of at least 0.025 mm.

14. The structural catalyst body of claim 1, wherein the individual flow channels have cross-sectional aspect ratio of at least 1.2:1.

15. The structural catalyst body of claim 1, wherein hydraulic diameter of the individual flow channels is at least 5.5 mm.

16. The structural catalyst body of claim 1 having transverse compressive strength of at least 1.0 kg/cm².

17. The structural catalyst body of claim 1, wherein the outer peripheral wall and inner partition walls are formed of a chemical composition comprising 50 to 100 weight percent an inorganic oxide composition of titania, zirconia, zeolites or combinations thereof.

18. The structural catalyst body of claim 17, wherein the outer peripheral wall and inner partition walls further comprise at least 0.1 weight percent catalytically active metal functional group.

19. The structural catalyst body of claim 18, wherein the catalytically active metal functional group includes one or more elements selected from the group consisting of vanadium, tungsten, molybdenum and copper.

20. The structural catalyst body of claim 1 having catalytic activity for nitrogen oxide removal at least 5% greater than a structural catalyst body of identical composition but lacking rectangular flow channels, surface protrusions and/or surface indentations

21. A catalyst module comprising:
a framework; and
a plurality of structural catalyst bodies disposed in the framework, the structural catalyst bodies comprising an outer peripheral wall and a plurality of inner partition walls defining individual flow channels of rectangular cross-section, wherein one or more of the inner partition walls comprise surface protrusions, surface indentations or combinations thereof.

22. The catalyst module of claim 21, wherein at least two of the structural catalyst bodies are placed in series.

23. The catalyst module of claim 22, wherein a gap exists between the two structural catalyst bodies, the gap having a length of at least 5 times hydraulic diameter of the individual flow channels.

24. A method of reducing the nitrogen oxide content of a fluid comprising:
flowing the fluid through a structural catalyst body comprising an outer peripheral wall and a plurality of inner partition walls defining individual flow channels of rectangular cross-section, wherein one or more of the inner partition walls comprise surface protrusions, surface indentations or combinations thereof; and
catalytically reacting at least one chemical species in the fluid stream.

25. The method of claim 24, wherein the fluid is an exhaust gas stream.

26. The method of claim 25, wherein the exhaust gas stream comprises greater than 1 g/Nm³ of fly ash.

27. The method of claim 24, wherein catalytically reacting at least one chemical species comprises catalytically reducing nitrogen oxides in the fluid stream.

28. A structural catalyst body comprising:
an outer peripheral wall and a plurality of inner partition walls defining individual flow channels of rectangular cross-section, the individual flow channels having a hydraulic diameter of at least 5.5 mm and an aspect ratio of at least 1.2:1;
a hydraulic diameter formed by the outer peripheral wall of at least 100 mm,
wherein at least 50 percent of the inner partition walls connected to the outer peripheral wall are at least 10 percent thicker on average than the remaining inner partition walls.

29. The structural catalyst body of claim 28, wherein all of the inner partition walls connected to the outer peripheral wall are at least 10 percent thicker on average than the remaining inner partition walls.

30. The structural catalyst body of claim 28, wherein inner partition walls adjacent to and collinear with thicker inner partition walls are also at least 10 percent thicker on average than the remaining inner partition walls.

31. The structural catalyst body of claim 28 having a transverse compressive strength of at least 1.5 kg/cm².
